(19) United States
(12) Patent Application Publication
(10) Pub. No.: US 2026/0115836 A1
(43) Pub. Date: Apr. 30, 2026

(54) METHOD AND APPARATUS FOR PROCESSING WORKPIECE BY USING LASER

(71) Applicant: ORC MANUFACTURING CO., LTD., Tokyo (JP)

(72) Inventors: Masahiko FUNAYAMA, Tokyo (JP); Masaru YAMAGA, Tokyo (JP); Taishi SHIMIZU, Tokyo (JP); Yuta KAWAMOTO, Tokyo (JP)

(73) Assignee: ORC MANUFACTURING CO., LTD., Tokyo (JP)

(21) Appl. No.: 19/066,811

(22) Filed: Feb. 28, 2025

(30) Foreign Application Priority Data
Oct. 30, 2024 (JP) 2024-190606

(51) Int. Cl. B23K 26/352

(52) U.S. Cl. CPC B23K 26/355

(57) ABSTRACT

A method for processing a workpiece by laser ablation includes: a) preparing a mask having at least one transparent pattern segment and at least one light-shielding pattern segment, the transparent pattern segment and the light-shielding pattern segment being along a pattern edge corresponding to a main scanning direction, b) scanning a line-shaped laser beam over the mask; c) projecting a pattern beam that passes through the mask onto a workpiece by using a projection optical system; and d) processing a processing area in the workpiece. The width or size of the transparent pattern segment and the light-shielding pattern segment are smaller than a resolution depending upon a wavelength of the line-shaped laser beam and a numerical aperture of the projection optical system.

### BACKGROUND OF THE INVENTION

### 1. Field of the Invention

The present invention relates to a laser-processing unit, and especially, a laser-processing method and a mask pattern used for the laser process.

### 2. Description of the Related Art

As for a substrate such as a printed wiring board, an accurately formed fine pattern is required for miniaturization of electronic equipment and high-density mounting onto a semiconductor. For example, the formation of a precision via hole or groove (trench) at the micron level is required for a multilayer substrate.

Suwa et al. (US 2021/0046584A1) discloses a laser ablation process (also called photoablation) that is one laser beam processing method. In the laser ablation, a laser beam with high energy density is formed and a scanner scans the laser beam over a fixed mask or reticle to project an image on a substrate or the like. By removing material from the surface of the substrate instantaneously in accordance to patterns formed on the mask or the reticle, a via hole or trench can be formed on the substrate. Misaka (U.S. Pat. No. 7,790,337B2) discloses a photomask in which a plurality of different mask patterns is formed.

### SUMMARY OF THE INVENTION

A method for processing a workpiece by laser ablation includes: a) preparing a mask having at least one transparent pattern segment and at least one light-shielding pattern segment, the transparent pattern segment and the light-shielding pattern segment configured along a pattern edge corresponding to a main-scanning direction, b) scanning a line-shaped laser beam over the mask; c) projecting a pattern beam that passes through the mask onto a workpiece by using a projection optical system; and d) processing a processing area in the workpiece. The width or size of the transparent pattern segment and the light-shielding pattern segment are smaller than a resolution depending upon the wavelength of the line-shaped laser beam and the numerical aperture of the projection optical system.

A mask with a mask pattern according to another aspect of the present invention includes at least one light-shielding pattern segment formed along a pattern edge of the mask pattern; and at least one transparent pattern segment formed along the pattern edge. The light-shielding pattern segment and the transparent pattern segment have a width or size smaller than a resolution depending upon the wavelength of the line-shaped laser beam and the numerical aperture of the projection optical system.

An apparatus for processing a workpiece by a laser ablation-according to another aspect of the present invention includes a mask stage configured to support the above mask; a line-shaped laser beam forming unit configured to form a line-shaped laser beam based on a laser beam oscillated from a light source; a scanner configured to scan the line-shaped laser beam over the mask; a projection optical system configured to project a pattern beam that through the mask onto the workpiece; and a processing stage configured to support the workpiece.

### BRIEF DESCRIPTION OF THE DRAWINGS

The present invention will be better understood from the description of the preferred embodiment of the invention set forth below together with the accompanying drawings, in which:

FIG. 1 is a schematic plan view showing a laser-processing unit according to one embodiment; and

FIG. 2 is a schematic block diagram of the laser-processing unit;

FIG. 3 is a view showing a mask pattern;

FIG. 4A is a view showing a cross-sectional intensity distribution of a line-shaped laser beam;

FIG. 4B is a cross-sectional view of a processed substrate;

FIG. 5 is a view showing a flowchart of a laser ablation process; and

FIG. 6 is a three-dimensional view showing intensity distribution of a pattern beam obtained by a calculated simulation.

### DESCRIPTION OF THE PREFERRED EMBODIMENTS

Hereinafter, the preferred embodiment of the present invention is described with references to the attached drawings.

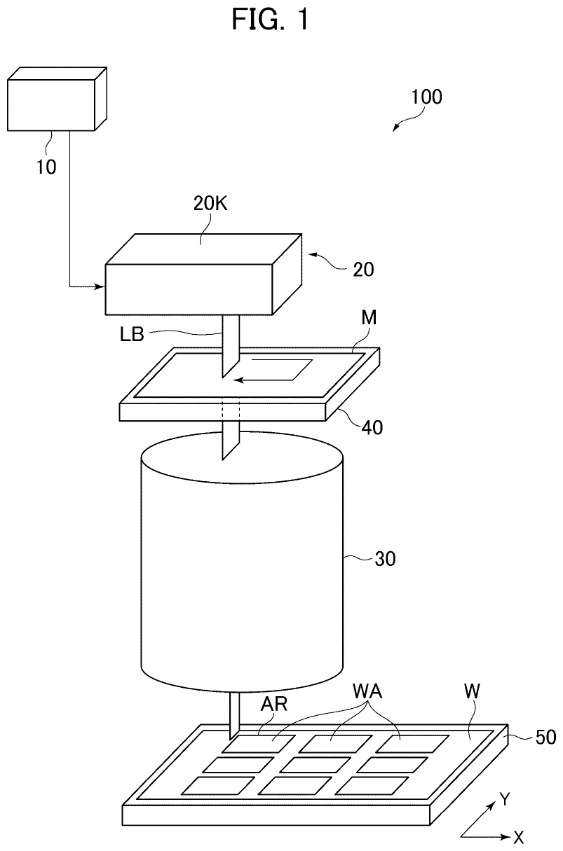

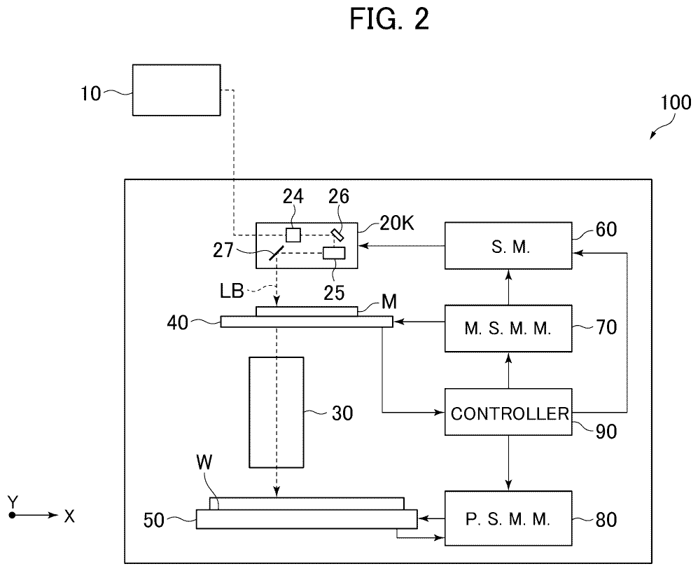

FIG. 1 is a schematic view showing a laser-processing unit according to the present embodiment. FIG. 2 is a schematic block diagram of the laser-processing unit according to the present embodiment.

A laser-processing unit or machine 100 forms a pattern on a substrate W by laser ablation and is equipped with a line-beam forming unit (illumination optical unit) 20, a projection optical system 30, a mask stage 40, and a processing stage 50, which are supported by a body (not shown). The line-beam forming unit 20, the mask stage 40 and the processing unit 50 are movable with respect to the body. A mask M and a substrate W are mounted on the mask stage 40 and the processing stage 50, respectively. The substrate W is herein a resin substrate such as a printed substrate.

The laser 10 is arranged adjacent to the body and oscillates a laser beam with high energy density. Herein, the laser 10 is an excimer laser that emits a KrF excimer laser beam with a wavelength of 248 nm. A laser beam oscillated from the laser 10 is directed to the line-beam forming unit 20 via a correcting optical system that adjusts an axis of the laser beam (not shown). Note that the laser source 10 may or may not be part of the laser-processing unit 100.

The line-beam forming unit (illumination optical unit) 20 is equipped with a line-beam forming optical system 25 including a lens array 24 and a cylindrical lens (not shown), angle switching mirrors 26 and 27, etc. The lens array 24 adjusts the distribution of the intensity of the incident laser beam. The line-beam forming optical system 25 forms a line-shaped laser beam LB from the luminous flux of the laser beam L that enters the line-beam forming optical unit 30. For example, the line-beam forming optical system 25 may form a rectangular beam having a length in the longitudinal direction of “26 mm” and a width of “0.1 mm” as a line-shaped laser beam LB (hereinafter, called a “line-beam”).

The line-beam forming unit 20 has a casing 20K that contains the line-beam forming optical system 25, etc. The casing 20K is supported by a scanning mechanism 60. The scanning mechanism 60 shown in FIG. 2 moves the line-beam forming unit 20 along the main scanning direction at a given speed to move the line-beam LB relative to the mask M along the main scanning direction. Herein, the X axis and Y axis are defined along the main scanning direction and the sub-scanning direction, respectively.

The angle-switching mirror 26 switches a mirror angle to shift the position of the laser beam LB irradiating the mask M along the sub-scanning direction (the Y axis direction), i.e., it switches an irradiation area on the mask M. Herein, the angle-switching mirror 26 is arranged at a conjugate point that is between the lens array 24 and the line-beam forming optical system 25.

The mask stage 40 supports the mask M and moves the mask M along the main scanning direction (the X-axis direction) and the sub-scanning direction (the Y-axis direction). Furthermore, the mask stage 40 may rotate the mask M. A mask-stage moving mechanism 70 drives the mask stage 40 based on signals from a position-detecting sensor (not shown).

The projection optical system 30 has focus points on the surfaces of the mask M and the substrate W. The projection optical system 30 projects light that passes through the mask M to the substrate W a light pattern. Herein, a projection magnification is defined to be 1.0. However, the projection optical system 30 may be a reduced-lens optical system, which has a projection magnification less than 1 (e.g., 0.5).

The processing stage 50 secures the substrate W with a vacuum adsorption process and moves the substrate W along the main scanning direction (the X-axis direction) and the sub-scanning direction (the Y-axis direction). The processing g stage 50 may rotate the substrate W. A processing-stage moving mechanism 80 drives the processing stage 50 based on signals from a position-detecting sensor (not shown). An alignment camera (not shown) that images alignment marks formed on the substrate W is provided adjacent to the processing stage 50.

In the substrate W, a copper wiring layer is formed on an epoxy resin and an insulation layer is further formed on the copper wiring layer. As described above, the laser 10 emits the excimer laser beams with high energy density towards the substrate W, which ablates, i.e., removes material from the substrate W so that a pattern corresponding to a mask pattern (hereinafter, “processing pattern”) WA is formed on the substrate W. For example, an interstitial via hole, blind via hole, wiring groove (trench), etc., can be formed on the substrate W.

While the scanning mechanism 60 moves the line-beam forming unit 20 in the main scanning direction (the X-axis direction), the line beam LB perpendicular to the main scanning direction (the X-axis direction) and parallel to the sub-scanning direction (the Y-axis direction) moves relative to the mask M (the mask stage 40), the projection optical system 30, and the substrate W (the processing stage 50). Thus, the mask M mounted on the mask stage 40 and the substrate W mounted on the processing stage 50 are scanned.

The size of the mask pattern is based on the size of the processing area AR of the substrate W and an imaging magnification of the projection optical system 30. The entire area in which the mask pattern can be formed has a size larger than the width of the line-beam LB along the longitudinal direction, i.e., the Y-axis direction. The scanning along the X-axis direction is repeatedly carried out on the mask M as the angle-switching mirror 26 switches the irradiated position of the line-beam LB along the Y-axis direction. Thus, the entire processed pattern WA is formed in one processing area AR.

The processing stage 50 moves step by step along the main scanning direction (the X-axis direction) and the sub-scanning direction (the Y-axis direction) wherever the processed pattern WA is formed at each processing area AR so that the laser ablation is carried out for the entire substrate W. After the laser ablation is finished, the substrate W is filled with a conductor such as copper. Note that a mask pattern MA corresponding to the total area of the substrate W may be formed on the mask M.

A controller 90 controls the angle-switching mirror 26 in the line-beam forming unit 20, the scanning mechanism 60, the mask-stage moving mechanism 70 and the processing-stage moving mechanism 80, etc. Concretely, the controller 90 positions the mask M and the substrate W, moves the irradiating position of the line-beam LB along the main scanning direction (the X-axis direction), and shifts the irradiating position along the sub-scanning direction (the Y-axis direction).

The controller 90 controls the laser ablation process. The controller 90 drives the laser 10 and controls the scanning mechanism 60 to scan the line-beam LB along the main scanning direction (the X-axis direction) in accordance to an input operation by an operator. Furthermore, the controller 90 controls a movement of the mask stage 40 and the processing stage 50, adjusts the deviation of the optical axis of the laser beam L, carries out an alignment process using the alignment cameras, and controls the opening and closing of the shutter mechanism.

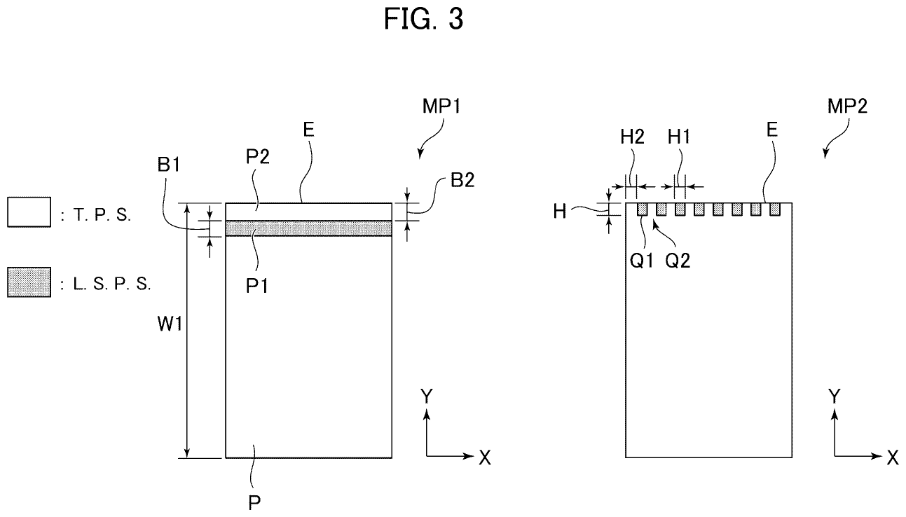

FIG. 3 is a view showing two mask patterns. A rectangular cavity is herein formed as a processed pattern WA.

In the mask M, either a rectangular mask pattern MP1 or a rectangular mask pattern MP2 is formed. Herein, the mask pattern MP1 is formed. The mask M is positioned on the mask stage 40 such that the edge E in the short direction aligns with the main scanning direction (the X-axis direction).

The mask pattern MP1 consists of a rectangular transparent pattern P and a bar-shaped light-shielding pattern P1 that is formed on part of the transparent pattern P. The light-shielding pattern segment P1 extends along the main scanning direction (the X-axis direction) and is formed a given distance away from the edge E with respect to the sub-scanning direction (the Y-axis direction). Consequently, a bar-shaped transparent pattern segment P2, which neighbors the light-shielding pattern segment P1, is formed on the edge E side.

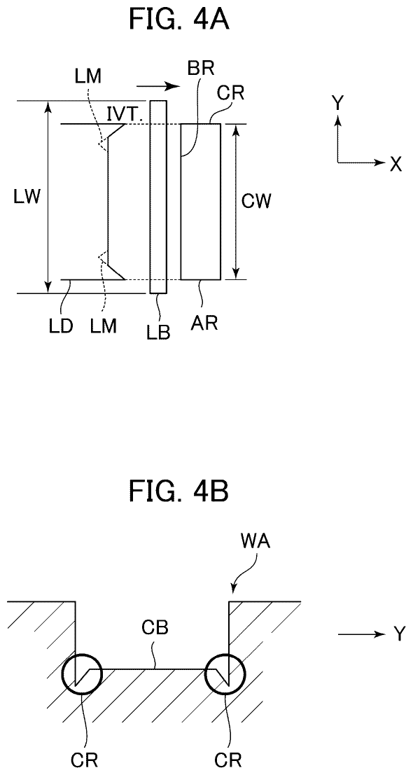

FIG. 4A illustrates an intensity distribution of a pattern beam that passes through the mask M. FIG. 4B is a cross-sectional view of the processed substrate W.

The width “LW” of the line-beam LB, which enters the mask M, is greater than the width “W1” of the mask pattern MP1 (see FIG. 3) along the sub-scanning direction (the Y-axis direction). Part of the line-beam LB passes through the mask pattern MP1 and irradiates the processing area AR as a pattern beam. The width “CW” of the processing area AR is herein the same as the width “W1” of the mask pattern MP1 along the sub-scanning direction (the Y-axis direction).

The laser beam L is a pulse beam with a high energy density and the line-beam LB formed by the line-beam forming unit 20 has a uniform intensity distribution. However, the intensity distribution of the line-beam LB after passing through the first mask pattern MP1, i.e., the pattern beam is not uniform since so-called “ringing” occurs in the intensity distribution.

FIG. 4A shows the intensity distribution of the pattern beam by numerical reference “LD”. Note that the magnitude of the intensity of the line-beam LB is represented in the main scanning direction (the X-axis direction). In the intensity distribution “LD” of the pattern beam, local peaks at both edges appear because of the ringing.

In the laser ablation using the line-beam LB with the above intensity distribution “LD”, a pattern beam with a high energy density continues irradiating the edges CR of the processing area AR during the scanning. Consequently, on the bottom surface CB of the processed pattern WA (cavity), the edges CR are curved out or sharpened deeply compared to the rest of the surface, and grooves are formed along the main scanning direction (the X-axis direction) by over-processing (See FIG. 4B).

On the other hand, as for the edges “BR” of the processing area AR along the sub-scanning direction (the Y-axis direction), the intensity of the pattern beam that reaches the processing area AR is not maintained at a high energy density level during the scanning. When the line-beam LB initially reaches the first mask pattern MP1, a pattern beam that is not formed as an image and has a relatively low intensity enters the processing area AR. The intensity of the pattern beam increases as the line-beam LB moves onto the first mask pattern MP1 and decreases again when the line-beam LB passes through the mask pattern MP1. Thereby, over-processing due to ringing does not occur at the edges “BR” of the processing area AR.

In this embodiment, the bar-shaped transparent pattern segment P2 and the light-shielding pattern segment P1 have widths B2 and B1, respectively, each of which does not allow the transparent pattern segment P2 and the light-shielding pattern segment P1 to be resolved or imaged.

The resolution of the laser processing unit 100 is obtained by the following formula:

$$R = K \times λ / NA \qquad ( 1 )$$

Note that R represents a resolution, A (nm) represents a wavelength of the laser beam L oscillated from the laser 10, and NA represents a numerical aperture of the projection optical system 30. A constant K is determined in accordance to an illumination condition, an exposure condition, etc.

The widths B1 and B2 of the light-shielding pattern segment P1 and the transparent pattern segment P2 may be presented by the following formula:

$$B x < R / Ms \qquad ( 2 )$$

Note that the widths “B1” or B2″ are herein represented by “Bx” comprehensively. “Ms” represents the magnification of a projection by the projection optical system 30. By setting the widths “B1” or B2″ to values that meets the formula (2), the light-shielding pattern segment P1 and the transparent pattern segment P2 are not resolved.

In the intensity distribution “LD” of the pattern beam, the beam intensity corresponding to the position of the light-shielding pattern segment P1 decreases since the light-shielding pattern segment P1 shields the line-beam LB (See numerical reference “LM”). Furthermore, the energy density of the pattern beam that reaches the edges CR and areas adjacent to the edges CR in the processing area AR is balanced or averaged due to the above resolution.

Consequently, the bottom surface CB of the processed pattern WA formed by laser ablation becomes flat, including the edges CR, and the occurrence of a groove at the edges CR is suppressed. The widths B1 and B2 of the light-shielding pattern segment P1 and the transparent segment P2 may be set arbitrarily within the range that meets the above formula (2). For example, the width B1 of the light-shielding pattern segment P1 may be less than the width B2 of the transparent pattern segment P2. The width B2 of the transparent pattern segment P2 may be also set to a value less than twice the value of the width B1 of the light-shielding pattern segment P1.

The constant K depends upon the illumination condition and the exposure condition, etc. For example, the constant K may be set to 0.25. The constant K may be set to a value in the range 0.25 to 0.60 in accordance to the illumination condition, the exposure condition, etc.

The mask pattern MP2 shown in FIG. 3 may be applied to the mask M instead of the mask pattern MP1.

In the mask M, rectangular light-shielding pattern segments Q1 are aligned with the pattern edge E at given intervals and rectangular transparent pattern segments Q2 are formed between neighboring light-shielding pattern segments Q1. The light-shielding pattern segments Q1 and the transparent pattern segments Q2, which are in contact with the pattern edge E, are complementary to one another.

The size of each of the light-shielding pattern segments Q1 is smaller than a resolution depending upon the above formula (1). The size of each of the transparent pattern segments is also than Q2 smaller the resolution. The light-shielding pattern segment Q1 and the transparent pattern segment Q2 have the same length “H” along the sub-scanning direction (the Y-axis direction), whereas the length “H1” along the main scanning direction (the X-axis direction) of the light-shielding pattern segment Q1 is less than the length “H2” of the transparent pattern segment Q2.

The rectangular and complementary light-shielding pattern segments Q1 and transparent pattern segments Q2 cause a periodic variation in the intensity distribution of the pattern beam adjacent to the pattern edge E during scanning by the line-beam LB. The energy density accumulated at the edge CR of the processed area AR during scanning is averaged since the size of the light-shielding pattern segment Q1 and the size of the transparent pattern segment Q2 are smaller than the resolution.

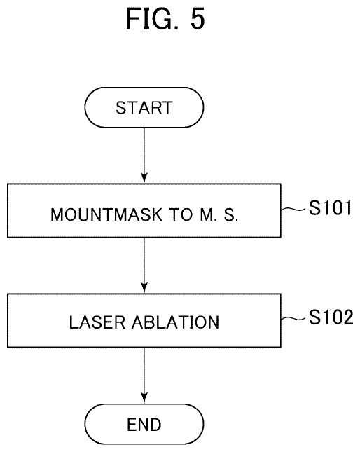

FIG. 5 is a flowchart of a laser ablation process.

The mask M with the mask pattern MP1 or the mask pattern MP2 is prepared and mounted on the mask stage 40 (S101). Then, a laser ablation process is carried out (S102).

In this way, the mask M with the mask pattern MP1 or the mask pattern MP2 may be selectively utilized for the laser processing unit 100. When the mask M with the pattern MP1 is used, the bar-shaped light-shielding pattern segment P1 extending along the main scanning direction (the X-axis direction) is formed. On the other hand, when the mask M with the mask pattern MP2 is used, the light-shielding pattern segments Q1 and the transparent pattern segments Q2 are alternately formed along the main scanning direction (the X-axis direction). The intensity of the pattern beam is averaged for areas adjacent to the pattern edge CR of the processed area AR in the substrate W.

A mask pattern other than a rectangular pattern such as a cavity may be applied. A mask pattern such as a trapezoid, polygon, or long hole (slit) pattern may also be applied. Furthermore, a mask pattern having a contour line such as a curved line with R or a free curve, etc., may be applied.

### Example

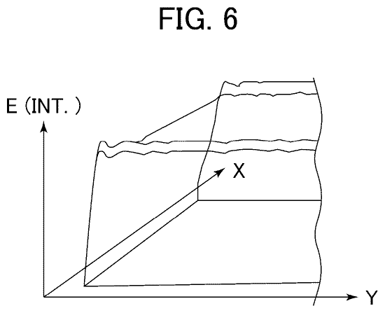

Hereinafter, one example of the laser processing unit 10 is explained with reference to FIG. 6. In the example, a mask with a mask pattern MP2 is modeled and the intensity distribution of a pattern beam that is projected onto a substrate when carrying out a laser ablation is calculated by a simulation.

The calculated simulation is carried out for the following conditions:
The wavelength of the laser beam is 248 nm;
The magnification of the projection is 0.25;
The number of the aperture (N) is 0.2;
The constant (K) is 0.25;
The dimensions of the mask pattern are 30 (μm)×13.8 (μm);
The dimensions of the light-shielding pattern segment are 1 (μm)×0.6 (μm);
The dimensions of the transparent pattern segment is 1 (μm)×1 (μm);
The width of the laser beam (X direction) is 0.1 (mm); and
The width of the laser beam (Y direction) is 26 (mm).

FIG. 6 shows an intensity distribution of a pattern beam. Note that the X-axis direction corresponds to the depth direction. As shown in FIG. 6, a ringing effect does not occur in the pattern edges of the intensity distribution along the X-axis direction. The calculated simulation based on the mask pattern MP1 also produced a similar conclusion. It was confirmed that a ringing effect did not occur in the pattern edges of the intensity distribution of the pattern beam.

Finally, it will be understood by those skilled in the arts that the foregoing description is of preferred embodiments of the device, and that various changes and modifications may be made to the present invention without departing from the spirit and scope thereof.

The present disclosure relates to subject matter contained in Japanese Patent Application No. 2024-190606 (filed on Oct. 30, 2024), which is expressly incorporated herein by reference, in its entirety.

1. A method for processing a workpiece by laser ablation, comprising:
a) preparing a mask having at least one transparent pattern segment and at least one light-shielding pattern segment, said transparent pattern segment and the light-shielding pattern segment configured along a pattern edge corresponding to a main scanning direction,
b) scanning a line-shaped laser beam over said mask;
c) projecting a pattern beam that passes through said mask onto a workpiece by using a projection optical system; and
d) processing a processing area in said workpiece, the width or size of said transparent pattern segment and said light-shielding pattern segment being smaller than a resolution depending upon a wavelength of the line-shaped laser beam and a numerical aperture of said projection optical system.

2. The method according to claim 1, wherein said light-shielding pattern segment is a bar-shaped light-shielding pattern segment along the pattern edge, said transparent pattern segment being formed between said light-shielding pattern segment and the pattern edge.

3. The method according to claim 2, wherein the width of said light-shielding pattern segment is less than that of said transparent pattern segment in the main scanning direction.

4. The method according to claim 1, wherein said light-shielding pattern segments and said transparent pattern segments are rectangular and alternately aligned with the pattern edge.

5. The method according to claim 4, wherein said light-shielding pattern segments and said transparent pattern segments are in contact with the pattern edge.

6. The method according to claim 4, wherein the size of said light-shielding pattern segment is smaller than that of said transparent pattern segment.

7. The method according to claim 1, wherein the processing step is accomplished by forming a cavity on a substrate.

8. A mask with a mask pattern, a pattern beam that passes through said mask being projected onto a workpiece by a projection optical system, comprising:
at least one light-shielding pattern segment formed along a pattern edge of said mask pattern; and
at least one transparent pattern segment formed along the pattern edge, said light-shielding pattern segment and said transparent pattern segment having a width or size smaller than a resolution depending upon a wavelength of the line-shaped laser beam and a numerical aperture of said projection optical system.

9. An apparatus for processing a workpiece by laser ablation, comprising:
a mask stage configured to support said mask recited in claim 8;
a line-shaped laser beam forming unit configured to form a line-shaped laser beam based on a laser beam oscillated from a light source;
a scanner configured to scan the line-shaped laser beam over said mask;
a projection optical system configured to project a pattern beam that passes through said mask onto said workpiece; and
a processing stage configured to support said workpiece.
